(19) United States
(12) Patent Application Publication
(10) Pub. No.: US 2009/0255093 A1
(43) Pub. Date: Oct. 15, 2009

(54) Handle grip

(76) Inventor: Chia-Wei Hsu, Fusing Hsiang (TW)

Correspondence Address: COOPER & DUNHAM, LLP, 30 Rockefeller Plaza, 20th Floor, NEW YORK, NY, 10112, US

(21) Appl. No.: 12/082,111

(22) Filed: Apr. 9, 2008

(51) Int. Cl. B62K 21/26; B25G 1/00

(52) U.S. Cl. 16/421; 74/551.9

(57) ABSTRACT

A handle grip has a body and at least one clamping ring. The body is tubular and has two ends, an outer surface and two mounting rings. The two mounting rings coaxially and respectively protrude from the two ends of the body. The clamping ring is mounted securely on one of the mounting rings of the body and has an opening, a fastening hole and a fastener. The opening is a slot formed through the clamping ring. The fastening hole is tangentially formed through the clamping ring and either side of the opening. A person may mount the body on handlebars of a motorcycle or a handle of a tool and use the clamping ring to ensure the body is held securely.

### BACKGROUND OF THE INVENTION

1. Field of Invention

The present invention relates to a grip, and more particularly to a handle grip that is mounted on a handle for improved liquid impermeability.

2. Description of the Related Art

Handle grips are wildly used in motorcycles, bicycles, heavy tools or the like and are securely mounted on handles of tools or handlebars of motorcycles and bicycles to allow a person securely hold the handle and reduce vibration when operating the motorcycle, bicycle or tool.

With reference to FIGS. 6 and 7, a grip in accordance with the prior art is mounted on a handle having an end and has a body (60), a fixing ring (61), a washer (62), an inner clamp (63), a fastener (64) and an outer clamp (65).

The body (60) is mounted on the handle is tubular and has a circumference, an inner end, an outer end and two clamping rims (614). Each clamping rim (614) is corresponds to the circumference of the body (60) and protrudes from the outer end of the body (60).

The fixing ring (61) is mounted on the inner end of the body (60) and has a mounting brace (611), a mount hole (612) and an inner surface (613). The mounting hole (612) is formed through the mounting brace (611).

The washer (62) is annular, corresponds to and is moveably mounted inside the fixing ring (61) adjacent to the body (60) and abuts the end of the handle.

The inner clamp (63) is an annular clamp, is movably mounted on the washer (62), corresponds to and is mounted on the inner surface (613) and is moveably and has two ends and two clamping holes (631). The clamping holes (631) are respectively formed through the ends of the inner clamp (63) and correspond to the mounting hole (612).

The fastener (64) corresponds to and is mounted through the mounting holes (612) and the clamping holes (631) to hold the body (60), the fixing ring (61), the washer (62) and the inner clamp (63) on the handle.

The outer clamp (65) is a C-shaped ring and an inner surface, two recesses (651), an opening (652), two fixing holes (653) and a fastener (654).

The recesses (651) correspond to the clamping rims (614) and are formed on the inner surface of the outer clamp (65).

The opening (652) is formed through the outer clamp (65) to form the outer clamp (651) as a C-ring.

The fixing holes (653) are tangentially formed through the outer clamp (65) either side of the opening (652).

The fastener (654) is mounted through the fixing holes (653) to mount the outer clamp (65) on the clamping rims (614) and hold the body (60) on the handle.

However, many elements are necessary, which increases cost of manufacture and installation. Furthermore, the handle rusts easily since water or moisture is may leak under the body (60) through a gap between the outer clamp (65) and the body (60) and become trapped between the handle and body (60).

The present invention provides a handle grip to obviate or mitigate the shortcomings of the conventional handle cover.

### SUMMARY OF THE INVENTION

The primary objective of the present invention is to provide a handle grip with reduced cost and improved liquid impermeability.

The handle grip has a body and at least one clamping ring. The body is tubular and has two ends, an outer surface and two mounting rings. The two mounting rings coaxially and respectively protrude from the two ends of the body. The clamping ring is mounted securely on one of the mounting rings of the body and has an opening, a fastening hole and a fastener. The opening is a slot formed through the clamping ring. The fastening hole is tangentially formed through the clamping ring and either side of the opening. A person may mount the body on a handlebar of a motorcycle or a handle of a tool and use the clamping ring to ensure the body is held securely.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a handle grip having two clamping rings in accordance with the present invention;

FIG. 2 is an exploded perspective view of the handle grip in FIG. 1;

FIG. 3 is an end view in partial section of the handle grip in FIG. 1;

FIG. 4 is an exploded perspective view of another embodiment of a handle grip having a clamping ring and a fastening cap in accordance with the present invention;

FIG. 5 is an end view in partial section of the handle grip in FIG. 4;

FIG. 6 is an exploded perspective view of a handle grip in accordance with the prior art; and

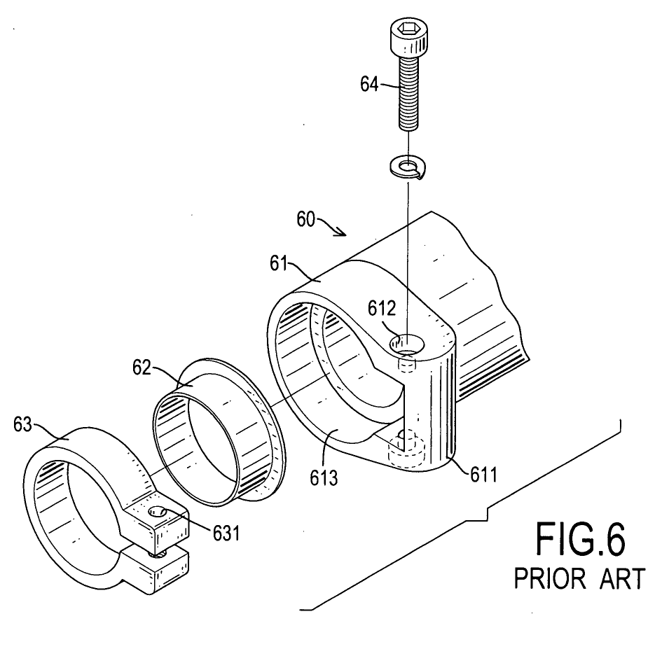

FIG. 7 is another exploded perspective view of the handle grip in accordance with the prior art.

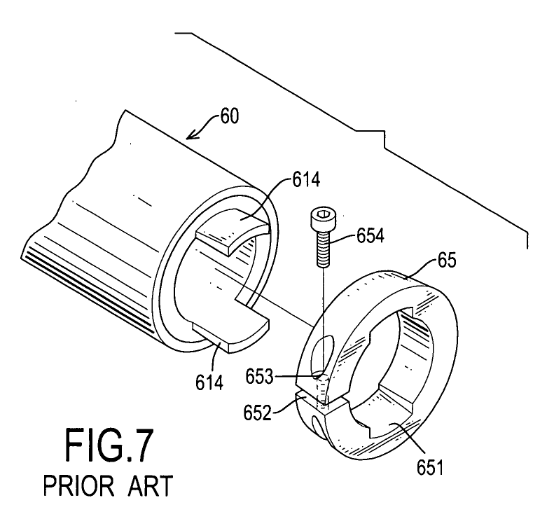

### DETAILED DESCRIPTION OF THE INVENTION

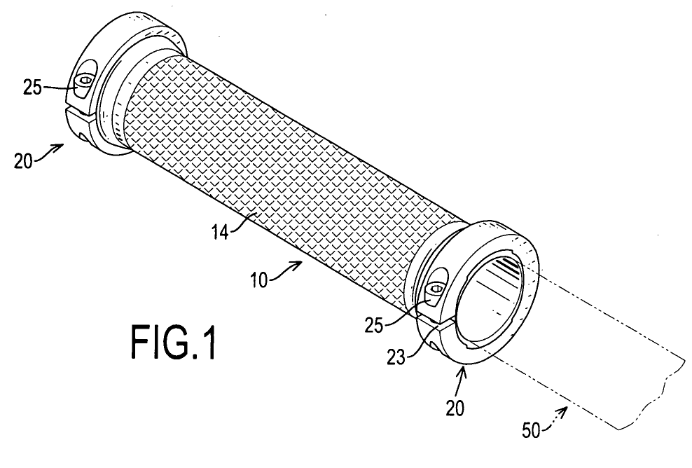

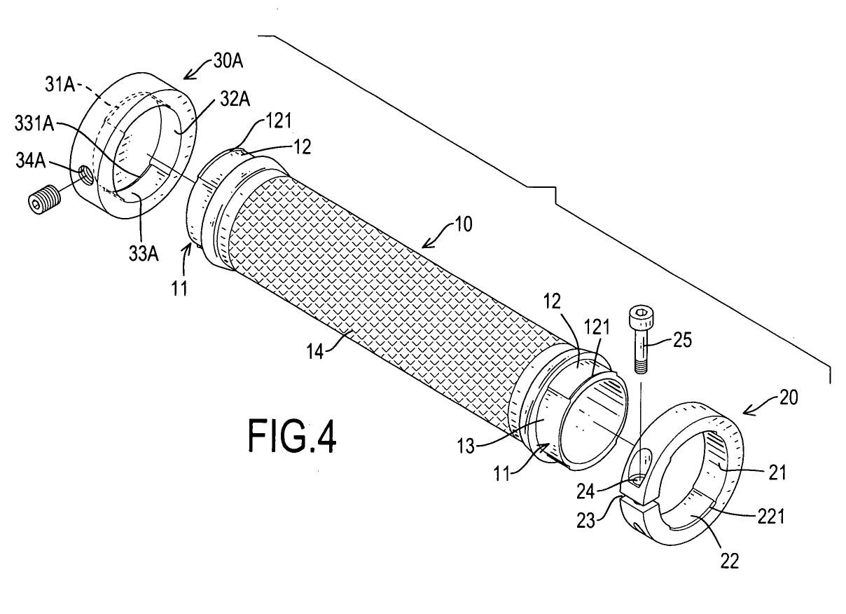

With reference to FIGS. 1 and 4, a handle grip in accordance with the present invention is mounted on a handle (50) and the handle grip comprises a body (10), at least one clamping ring (20) and may have a fastening cap (30A). The handle (50) may be a handle for a tool, a handlebar for a motorcycle or the like.

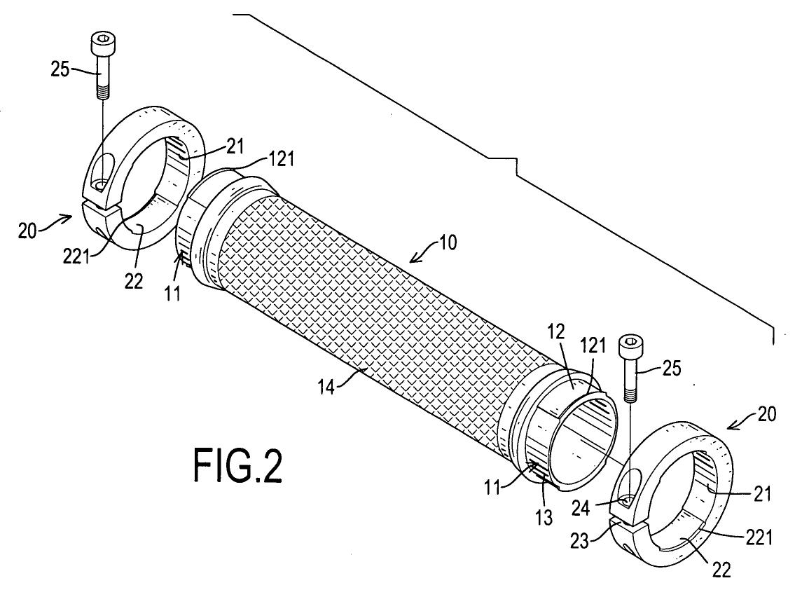

With further reference to FIG. 2, the body (10) is tubular, has two ends, an outer surface, two mounting rings (11) and may have a frictional cover (14).

The two mounting rings (11) coaxially and respectively protrude from the two ends of the body (10). Each mounting ring (11) is tractable and has at least one protrusion (12). The at least one protrusion (12) is formed on and protrudes radially from the mounting ring (11) and has an outer surface, an outer edge and may have a rim (121). The rim (121) protrudes from the outer surface of the protrusion (12) near the outer edge. In a preferred embodiment of the present invention, each mounting ring (11) comprises two protrusions (12).

The frictional cover (14) is mounted on the outer surface of the body (10), may be plastic, rubber or the like, may be resilient to prevent vibrations passing therethrough and may comprise multiple ribs, grooves or a combination thereof to be easily gripped even when wet.

The at least one clamping ring (20) is respectively mounted securely on at least one of the mounting rings (1) of the body (10) and each one has an inner surface (21), at least one recess (22), an opening (23), a fastening hole (24) and a fastener (25).

The inner surface (21) of the clamping ring (20) is mounted securely on one of the mounting rings (11) to hold the body (10) on the handle (50).

The at least one recess (22) is formed on the inner surface (21) of the clamping ring (20), corresponds to and is mounted around one of the at least one protrusion (12) and has an outer edge and may have a rim recess (221).

The rim recess (221) corresponds to the rim (121) and is formed in the outer edge of the recess (22). In the preferred embodiment of the present invention, the clamping ring (20) has two recesses (22). Each recess (22) and rim recess (221) are respectively mounted on one of the protrusions (12) and the corresponding rim (121).

The opening (23) is formed through the clamping ring (20).

The fastening hole (24) is tangentially formed through the clamping ring (20) either side of the opening (23) and is threaded in one side of the opening (23).

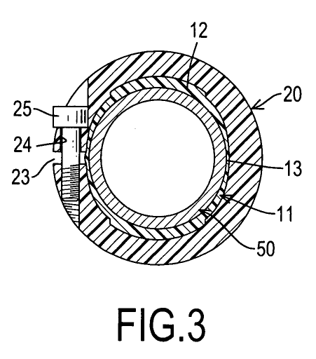

With further reference to FIG. 3, the fastener (25) is movably mounted through the fastening hole (24) to hold the clamping ring (20) securely on one of the mounting rings (11) of the body (10), thereby the body (10) is fastened on the handle (50) securely. When the fastener (25) is tightened, the opening (23) is reduced in size allowing the clamping ring (20) to slightly deform the mounting ring (11) to ensure the body (10) is fastened securely on the handle (50) and reduce water or moisture entering between the body (10) and the handle (50) and rusting the body (10).

The fastening cap (30A) is mounted securely on one of the mounting rings (11) of the body (10), is a round cap and has a sealed end (31A), an inner annular surface (32A), at least one recess (33A), an mounting hole (34A) and a set screw (35A).

Each recess (33A) is formed on the inner annular surface (32A) of the fastening cap (30A), corresponds to one of the at least one protrusion (12) and is mounted on the corresponding protrusion (12) when the fastening cap (30A) is mounted on the one end of the body (10) and has an inner edge formed adjacent to the sealed end and may have a rim recess (331A).

The rim recess (331A) corresponds to the rim (121) and is formed in the recess (33A) and adjacent to the inner edge.

The mounting hole (34A) is formed radially through the fastening cap (30A).

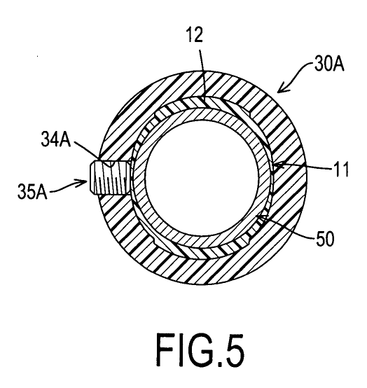

With further reference to FIG. 5, the set screw (35A) corresponds to and is movably mounted through the mounting hole (34A) and selectively protrudes from the inner annular surface (32A).

The handle grip in accordance with the present invention may comprise one clamping ring (20) and one fastening cap (30A). When assembling, the clamping ring (20) and the body (10) are mounted securely on the handle (50) then the fastening cap (30A) is securely mounted on the body (10) at a distal end of the handle (50) using the set screw (35A) abutting the mounting ring (11).

Therefore, the body (10) of the handle grip may be easily mounted on the handle (50) tightly using the clamping ring (20) and the fastening cap (30A) comprising fewer components than prior art and having improved liquid impermeability.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A handle grip comprising
a body being tubular and having
two ends;
an outer surface; and
two mounting rings coaxially and respectively protruding from the two ends of the body, each mounting ring being tractable and having at least one protrusion, each one of the at least one protrusion having
an outer surface; and
an outer edge; and
at least one clamping ring being respectively mounted securely on at least one of the mounting rings of the body and each one of the at least one clamping ring having
an inner surface being mounted securely on a corresponding one of the mounting rings;
at least one recess being formed on the inner surface of the clamping ring, corresponding to and being mounted around one of the at least one protrusion on the corresponding mounting ring and having an outer edge;
an opening being a slot formed through the clamping ring;
a fastening hole being tangentially formed through the clamping ring either side of the opening; and
a fastener being movably mounted in the fastening hole to hold the clamping ring securely on one of the mounting rings of the body.

2. The handle grip as claimed in claim 1, wherein the handle grip has two clamping rings being respectively mounted on the mounting rings of the body.

3. The handle grip as claimed in claim 2, wherein the body further has a frictional cover being mounted on the outer surface of the body.

4. The handle grip as claimed in claim 3, wherein
each mounting ring comprises two protrusions; and
each clamping ring has two recesses.

5. The handle grip as claimed in claim 4, wherein
each protrusion further has a rim protruding from the outer surface of the protrusion near the outer edge; and
each recess of each clamping ring further has a rim recess, the rim recess corresponding to the rim of a corresponding protrusion and being formed in the outer edge of the recess.

6. The handle grip as claimed in claim 1, wherein the handle grip has one clamping ring and further has a fastening cap being mounted securely on one of the mounting rings of the body, being a round cap and having
a sealed end;
an inner annular surface;
at least one recess being formed on the inner annular surface of the fastening cap and respectively corresponding to and being mounted on the at least one protrusion on a corresponding mounting ring, and each one of the at least one recess having an inner edge being formed adjacent to the sealed end;
a mounting hole being formed radially through the fastening cap; and
a set screw corresponding to and being movably mounted in the mounting hole and selectively protruding from the inner annular surface of the fasting cap.

7. The handle grip as claimed in claim 6, wherein the body further has a frictional cover being mounted on the outer surface of the body.

8. The handle grip as claimed in claim 7, wherein
each mounting ring has two protrusions;
the clamping ring has two recesses; and
the fastening cap has two recesses.

9. The handle grip as claimed in claim 8, wherein
each one of the protrusions further has a rim protruding from the outer surface of the protrusion near the outer edge;
each recess of the clamping ring further has a rim recess, the rim recess corresponding to the rim of a corresponding protrusion and being formed on the recess near the outer edge; and
each recess of the fastening cap has a rim recess corresponding to the rim of a corresponding protrusion and being formed in the recess near the inner edge.
